(19) United States
(12) Patent Application Publication
(10) Pub. No.: US 2025/0012596 A1
(43) Pub. Date: Jan. 9, 2025

(54) MAP GENERATION APPARATUS AND MAP GENERATION SYSTEM

(71) Applicant: Honda Motor Co., Ltd., Tokyo (JP)

(72) Inventor: Yuki Okuma, Tokyo (JP)

(21) Appl. No.: 18/758,218

(22) Filed: Jun. 28, 2024

(30) Foreign Application Priority Data
Jul. 5, 2023 (JP) 2023-110507

(51) Int. Cl. G01C 21/00

(52) U.S. Cl. CPC G01C 21/3819; G01C 21/3859

(57) ABSTRACT

A map generation apparatus includes: a processor and a memory coupled to the processor. The memory is configured to store travel trajectory information indicating a travel trajectory of a vehicle. The processor is configured to perform: recognizing surrounding situation of the vehicle; calculating a curvature of the travel trajectory in a specific scene where traveling map information has not been acquired, based on the travel trajectory information stored in the memory; estimating a lane shape in the specific scene based on the curvature; and adding the lane shape to the traveling map information.

### CROSS-REFERENCE TO RELATED APPLICATION

This application is based upon and claims the benefit of priority from Japanese Patent Application No. 2023-110507 filed on Jul. 5, 2023, the content of which is incorporated herein by reference.

### BACKGROUND OF THE INVENTION

### Field of the Invention

The present invention relates to a map generation apparatus and a map generation system configured to generate a map based on information acquired by a vehicle.

### Description of the Related Art

As this type of technology, there is a map generation apparatus that generates a map on the basis of information acquired by an in-vehicle sensor mounted on a vehicle.

For example, in the technique disclosed in JP 2010-026326 A, an entry point and an exit point of an intersection are connected in an S shape or a single arc by using a Bezier curve on the basis of an advancing direction. Thus, for example, in the case of a deformed intersection where an entry and an exit of an intersection are offset from each other, a smooth lane shape may not be obtained.

Smooth movement of a vehicle can be performed by obtaining a smooth lane shape in an intersection in map data, and thus it is possible to improve traffic convenience and safety. This can contribute to development of a sustainable transportation system.

### SUMMARY OF THE INVENTION

An aspect of the present invention is a map generation apparatus, including: a processor and a memory coupled to the processor. The memory is configured to store travel trajectory information indicating a travel trajectory of a vehicle. The processor is configured to perform: recognizing surrounding situation of the vehicle; calculating a curvature of the travel trajectory in a specific scene where traveling map information has not been acquired, based on the travel trajectory information stored in the memory; estimating a lane shape in the specific scene based on the curvature; and adding the lane shape to the traveling map information.

Another aspect of the present invention is a map generation system, including: the map generation apparatus; and a server device configured to acquire and store the travel trajectory information from a plurality of the vehicle. The processor calculates the curvature of the travel trajectory in the specific scene based on the travel trajectory information of the vehicle other than a two-wheeled vehicle from among the travel trajectory information stored in the server device.

### BRIEF DESCRIPTION OF THE DRAWINGS

The objects, features, and advantages of the present invention will become clearer from the following description of embodiments in relation to the attached drawings, in which:

FIG. 1 is a schematic diagram illustrating an example of a deformed intersection;

FIG. 2 is a block diagram illustrating an example of a schematic configuration of a vehicle control system including a map generation apparatus according to an embodiment of the present invention;

FIG. 3 is a block diagram illustrating an example of a main configuration of the map generation apparatus according to the present embodiment;

FIG. 4A is a schematic diagram illustrating a travel trajectory in a travel section including an intersection on a two-dimensional map;

FIG. 4B is a schematic diagram illustrating a distribution of travel trajectories excluding an outlier;

FIG. 5A is a schematic diagram illustrating a first estimation example for a lane shape;

FIG. 5B is a diagram illustrating a curvature of a travel trajectory in FIG. 5A;

FIG. 6A is a schematic diagram describing a method according to the first estimation example in more detail;

FIG. 6B is a diagram illustrating an example of a travel trajectory from an entrance to an exit of the intersection and a distance to a virtual lane boundary line;

FIG. 7A is a schematic diagram illustrating a second estimation example for the lane shape;

FIG. 7B is a schematic diagram illustrating a third estimation example for the lane shape;

FIG. 8 is a flow chart showing an example of process executed by a controller of FIG. 3; and

FIG. 9 is a diagram illustrating an example of a configuration of a road map generation system according to a first modification example.

### DETAILED DESCRIPTION OF THE INVENTION

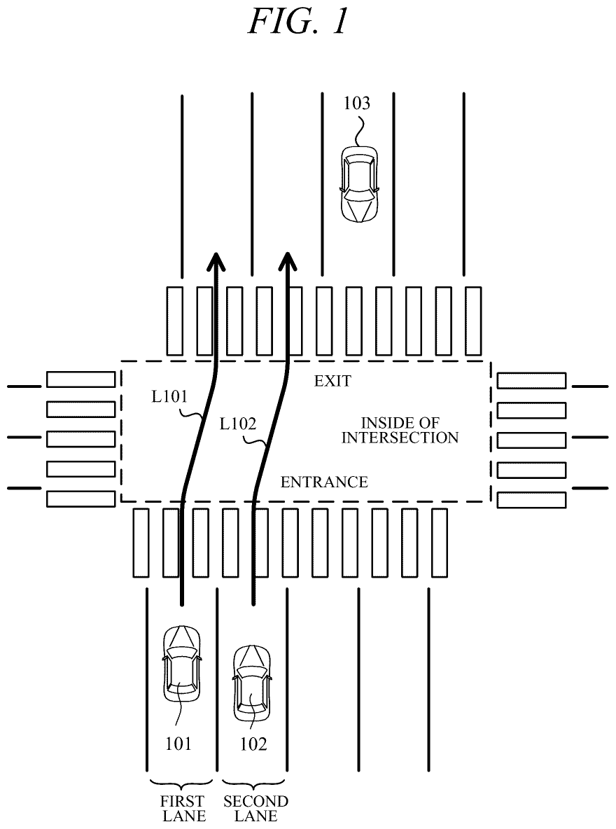

Hereinafter, an embodiment of the present invention will be described with reference to FIGS. 1 to 9.

### SUMMARY

A map generation apparatus according to the present embodiment is configured to generate, for example, a map (an environment map that will be described later) used when a vehicle (automated driving vehicle) having an automated driving function travels. Hereinafter, a vehicle on which the map generation apparatus according to the present embodiment is mounted may be referred to as a host vehicle to be distinguished from other vehicles.

The map generation apparatus generates a map when a driver manually drives a host vehicle. Therefore, the map generation apparatus may also be provided in a vehicle (manual driving vehicle) not having an automated driving function.

The map generation apparatus generates an environment map including three-dimensional point group data by using detection values detected by an external sensor group that will be described later while the host vehicle is traveling. For example, edges indicating an outline of an object as a feature are extracted from camera images acquired by a camera included in the external sensor group on the basis of luminance and color information for each pixel, and a feature point is extracted by using the edge information. The feature point is, for example, a point on the edges or an intersection point of the edges, and corresponds to a division line on a road surface, a corner of a building, a corner of a road sign, or the like. The map generation apparatus obtains a distance from a host vehicle to the above feature point with a light detection and ranging (LiDAR) or a radar included in the external sensor group, records the feature point on an environment map, and generates an environment map of the surroundings of the road on which the host vehicle has traveled.

Note that, the map generation apparatus may be provided not only in a manual driving vehicle but also in an automated driving vehicle capable of switching from an automated driving mode that does not require a driving operation of a driver to a manual driving mode that requires a driving operation of a driver. Hereinafter, the map generation apparatus will be described assuming that the map generation apparatus is provided in an automated driving vehicle.

### <Example of Deformed Intersection>

FIG. 1 is a schematic diagram illustrating an example of an intersection where an entrance through which a vehicle enters the intersection and an exit through which the vehicle exits the intersection are offset, in other words, a deformed intersection where a position obtained by extending a travel lane toward the entrance of the intersection into the intersection and a position of the exit of the intersection are misaligned. It is assumed that a guide line or the like (including a road marking and a cone) for guidance along a travel route in the intersection is not provided in the intersection surrounded by a rectangular dashed line.

A road provided in the vertical direction across the intersection is a road having a total of four lanes including two lanes on each side. In the example in FIG. 1, in a case where a host vehicle 101 traveling upward in a first lane and another vehicle 102 traveling similarly upward in a second lane travel straight through the intersection, it is correct that the vehicles travel upward in the intersection following routes L101 and L102 of arrows, respectively.

In a case where the host vehicle 101 and the other vehicle 102 traveling in the first lane and the second lane in the automated driving mode travel straight through the intersection, the map generation apparatus according to the present embodiment estimates lane shapes in the intersection such that the vehicles follow the routes L101 and L102, respectively, in the intersection, and generates an environment map including the estimated lane shapes. Hereinafter, such a map generation apparatus will be described in detail.

### <Automated Driving Vehicle>

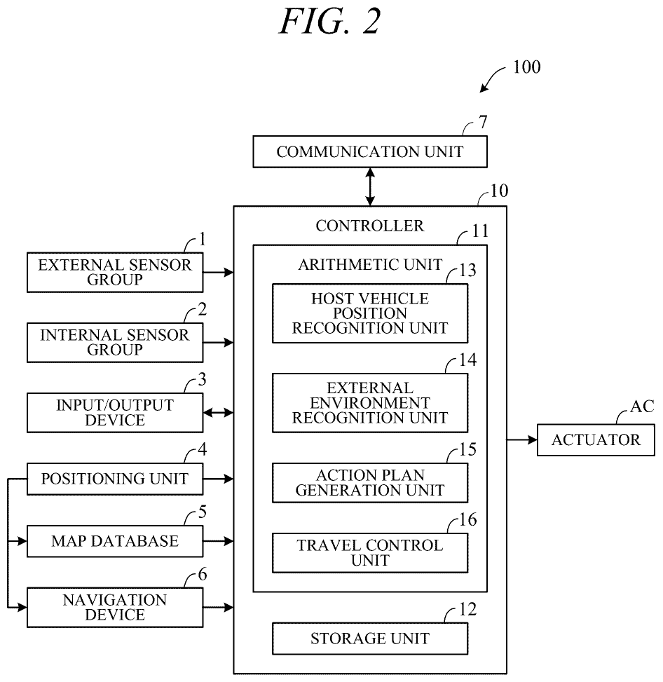

First, a configuration of an automated driving vehicle will be described. A host vehicle may be any of an engine vehicle including an internal combustion engine (engine) as a traveling drive source, an electric vehicle including a traveling motor as a traveling drive source, and a hybrid vehicle including an engine and a traveling motor as traveling drive sources. FIG. 2 is a block diagram illustrating an example of a schematic configuration of a vehicle control system 100 including the map generation apparatus according to the embodiment.

As illustrated in FIG. 2, the vehicle control system 100 mainly includes a controller 10, and an external sensor group 1, an internal sensor group 2, an input/output device 3, a positioning unit 4, a map database 5, a navigation device 6, a communication unit 7, and a traveling actuator AC, which are each communicably connected to the controller 10 via a controller area network (CAN) communication line or the like.

“External sensor group 1” is a generic term for a plurality of sensors (external sensors) that detect an external situation that is surrounding information of the host vehicle. The external sensor group 1 includes, for example, a camera that includes an imaging element (image sensor) such as a CMOS sensor and captures an image of the vicinity of the host vehicle (the front, the rear, and the side), a LiDAR that detects a position of an object near the host vehicle (a distance, a direction, or the like from the host vehicle) by emitting laser light and detecting reflected light, and a radar that detects a position of an object near the host vehicle by emitting an electromagnetic wave and detecting a reflected wave.

“Internal sensor group 2” is a generic term for a plurality of sensors (internal sensors) that detect a traveling state of the host vehicle. The internal sensor group 2 includes, for example, a vehicle speed sensor that detects a vehicle speed of the host vehicle, an acceleration sensor that detects acceleration in a front-rear direction and a left-right direction of the host vehicle, and a rotation speed sensor that detects a rotation speed of a traveling drive source. The internal sensor group 2 also includes sensors that detect a driver's driving operation such as an operation on an accelerator pedal, an operation on a brake pedal, or an operation on a steering wheel in the manual driving mode.

“Input/output device 3” is a generic term for devices to and from which a command is input by a driver or information is output to the driver. For example, the input/output device 3 includes various switches to which a driver inputs various commands by operating an operation member, a microphone to which the driver inputs commands with voice, a display that provides information to the driver via a display image, a speaker that provides information to the driver with voice, and the like.

The positioning unit 4 includes a positioning sensor that receives a positioning signal transmitted from a positioning satellite, and measures a current position (latitude, longitude, and altitude) of the host vehicle by using positioning information received by the positioning sensor. The positioning satellite is an artificial satellite such as a GPS satellite or a quasi-zenith satellite. The positioning sensor may be included in the internal sensor group 2. The positioning unit 4 may be referred to as a global navigation satellite system (GNSS) unit.

The map database 5 is a device that stores general map information used for the navigation device 6, and includes, for example, a hard disk or a semiconductor element. The map information includes road position information, information regarding a road shape (a curvature or the like), and position information regarding intersections and branch points.

The map information stored in the map database 5 is different from the map information of the highly accurate environment map stored in a storage unit 12 of the controller 10.

The navigation device 6 is a device that searches for a target route on roads to a destination that has been input by a driver and that performs guidance along the target route. The entry of the destination and the guidance along the target route are performed via the input/output device 3. The target route is calculated on the basis of a current position of the host vehicle measured by the positioning unit 4 and the map information stored in the map database 5. The current position of the host vehicle may be measured by using detection values of the external sensor group 1, and the target route may be calculated on the basis of the current position and the environment map information stored in the storage unit 12.

The communication unit 7 communicates with various servers (not illustrated) via a network including a wireless communication network typified by the Internet, a mobile telephone network, or the like, and acquires map information, traveling history information of other vehicles, traffic information, and the like from the servers regularly or at a given timing. The network includes not only a public wireless communication network but also a closed communication network provided for every predetermined management area, for example, a wireless LAN, Wi-Fi (registered trademark), and Bluetooth (registered trademark). In a case where the acquired map information is the general map information, the map in the map database 5 is updated. In a case where the acquired map information is the environment map information, the environment map in the storage unit 12 is updated. The communication unit 7 can also communicate with other vehicles.

The actuator AC is a traveling actuator for controlling traveling of the host vehicle. In a case where the traveling drive source is an engine, the actuators AC include a throttle actuator that adjusts an opening (throttle opening) of a throttle valve of the engine. In a case where the traveling drive source is a traveling motor, the actuators AC includes the traveling motor. The actuator AC also includes a brake actuator that operates a braking device of the host vehicle and a steering actuator that drives the steering device.

The controller 10 includes an electronic control unit (ECU). More specifically, the controller 10 is configured to include a computer including a calculation unit 11 such as a CPU (microprocessor), the storage unit 12 such as a ROM and a RAM, and other peripheral circuits (not illustrated) such as an I/O interface. Note that a plurality of ECUs having different functions such as an ECU for engine control, an ECU for traveling motor control, and an ECU for a braking device may be individually provided. However, in FIG. 2, the controller 10 is illustrated as an aggregation of these ECUs for the sake of convenience.

The storage unit 12 stores highly accurate environment map information. The environment map includes position information for roads, information regarding road shapes (curvatures or the like), information regarding road gradients, position information for intersections and branch points, information regarding the number of traffic lanes (travel lanes), information regarding traffic lane widths and position information for every traffic lane (information regarding center positions of traffic lanes or boundary lines of traffic lane positions), position information for landmarks (traffic lights, signs, buildings, and the like) as marks on a map, and information regarding road surface profiles such as irregularities of road surfaces.

The storage unit 12 stores an environment map (its data) and reliability information indicating the reliability of the environment map as environment map information. The storage unit 12 may further store travel trajectory information indicating a travel trajectory based on detection values of the external sensor group 1 and the internal sensor group 2.

The calculation unit 11 includes a host vehicle position recognition unit 13, an external environment recognition unit 14, an action plan generation unit 15, and a travel control unit 16 as functional configurations.

The host vehicle position recognition unit 13 recognizes a position of the host vehicle (host vehicle position) on the map on the basis of the position information for the host vehicle obtained by the positioning unit 4 and the map information in the map database 5. The host vehicle position may be recognized by using the environment map information stored in the storage unit 12 and the surrounding information of the host vehicle detected by the external sensor group 1, and thus the host vehicle position can be recognized with high accuracy.

When the host vehicle position can be measured by a sensor installed on a road or outside a road side, the host vehicle position may be recognized through communication with the sensor via the communication unit 7.

The host vehicle position recognition unit 13 further performs a host vehicle position estimation process in parallel with a map generation process performed by a map generation unit 114 that will be described later. In the position estimation, a position of the host vehicle is estimated on the basis of a change in a position of a feature (feature point) with the passage of time. The map generation process and the position estimation process are simultaneously performed according to a simultaneous localization and mapping (SLAM) algorithm by using signals from the external sensor group 1 (the camera or the LiDAR), for example.

The external environment recognition unit 14 recognizes an external situation around the host vehicle on the basis of signals from the external sensor group 1. For example, a position, a speed, and acceleration of a nearby vehicle (a preceding vehicle or a following vehicle) traveling near the host vehicle, a position of a nearby vehicle stopped or parked near the host vehicle, and positions and states of other objects are recognized. Other objects include signs, traffic lights, markings such as division lines and stop lines on roads, buildings, guardrails, utility poles, signboards, pedestrians, bicycles, and the like. The states of other objects include colors of a traffic light (red, green, and yellow), and a moving speed and an orientation of a pedestrian or a bicycle. Division lines include white lines (as well as lines of different colors such as yellow), curbstone lines, road studs, and the like, and may be referred to as lane marks.

The action plan generation unit 15 generates a travel trajectory (target trajectory) of the host vehicle from the current point of time to a predetermined time ahead on the basis of, for example, a target route calculated by the navigation device 6, the map information stored in the map database 5 (or the environment map information stored in the storage unit 12 may be used), the host vehicle position recognized by the host vehicle position recognition unit 13, and the external situation recognized by the external environment recognition unit 14. In a case where there are a plurality of trajectories serving as target trajectory candidates on the target route, the action plan generation unit 15 selects, from among these trajectories, an optimal trajectory that satisfies some criteria in terms of compliance with laws and regulations and efficient and safe travel and then sets this selected trajectory as a target trajectory. The action plan generation unit 15 generates an action plan corresponding to the generated target trajectory. The action plan generation unit 15 generates various action plans corresponding to passing traveling for passing a preceding vehicle, lane change traveling for changing a travel lane, tracking traveling for tracking a preceding vehicle, lane keeping traveling for keeping a lane without departing from a travel lane, deceleration traveling or acceleration traveling, and the like. When the target trajectory is generated, first, the action plan generation unit 15 determines a travel mode, and then generates the target trajectory on the basis of the travel mode.

In the automated driving mode, the travel control unit 16 controls each of the actuators AC such that the host vehicle travels along the target trajectory generated by the action plan generation unit 15. More specifically, the travel control unit 16 calculates a requested drive force for obtaining target acceleration for each unit time calculated by the action plan generation unit 15 in consideration of traveling resistance determined according to a road gradient or the like in the automated driving mode. For example, the actuators AC are feedback-controlled such that an actual acceleration detected by the internal sensor group 2 becomes the target acceleration. More specifically, the actuators AC are controlled such that the host vehicle travels at the target vehicle speed and the target acceleration. When a driving mode is the manual driving mode, the travel control unit 16 controls each actuator AC according to a travel command (a steering operation or the like) from the driver acquired by the internal sensor group 2.

### <Map Generation Apparatus>

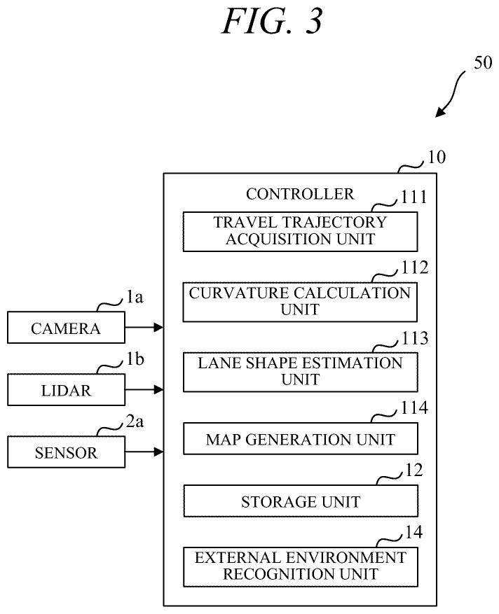

FIG. 3 is a block diagram illustrating an example of a main configuration of a map generation apparatus 50 according to the embodiment. The map generation apparatus 50 is included in the vehicle control system 100 in FIG. 2. In FIG. 3, the map generation apparatus 50 includes a camera 1a, a LiDAR 1b, a sensor 2a, and the controller 10.

The camera 1a is a monocular camera having an image sensor such as a CMOS sensor, and is included in the external sensor group 1 in FIG. 2. The camera 1a may be a stereo camera. The camera 1a is attached at a predetermined position in the front part of the host vehicle, and continuously captures an image of a space in front of the host vehicle at a predetermined frame rate to acquire an image (camera image) of the nearby vehicle described above and a target object as another object.

Note that, the target object may be detected by the LiDAR 1b or the like together with the camera 1a or instead of the camera 1a.

The LiDAR 1b is also included in the external sensor group 1. The LiDAR 1b is attached to be directed forward of the host vehicle such that a region to be observed during traveling is included in a field of view (hereinafter referred to as an FOV) of the LiDAR 1b. The LiDAR 1b intermittently applies laser light to a plurality of detection points (may be referred to as irradiation points) in the FOV to acquire, for each detection point, point information in which the applied laser light is reflected (scattered) and returned at a certain point on a surface of an object. The point information includes a distance from a laser source (host vehicle) to the point, the intensity of the laser light that has been reflected (scattered) and returned, and a relative velocity between the laser source and the point. In the embodiment, data including the point information of a plurality of detection points in the FOV will be referred to as point group data. The LiDAR 1b continuously acquires a predetermined number (the number of detection points in the FOV) of point group data per frame at a predetermined frame rate.

The sensor 2a is a detector used to calculate a movement amount and a movement direction of the host vehicle. The sensor 2a is included in the internal sensor group 2, and includes, for example, a vehicle speed sensor and a yaw rate sensor. That is, the controller 10 (host vehicle position recognition unit 13) calculates the movement amount of the host vehicle by integrating a vehicle speed detected by the vehicle speed sensor, calculates a yaw angle by integrating a yaw rate detected by the yaw rate sensor, and estimates a position of the host vehicle through odometry when a map is generated. Note that, a configuration of the sensor 2a is not limited thereto, and the controller 10 may estimate a position of the host vehicle by using information of another sensor.

The controller 10 in FIG. 3 includes a travel trajectory acquisition unit 111, a curvature calculation unit 112, a lane shape estimation unit 113, and a map generation unit 114 in addition to the storage unit 12 and the external environment recognition unit 14 as functional configurations of the calculation unit 11 (FIG. 2).

The storage unit 12 stores environment map information as described above. The environment map stored in the storage unit 12 includes an environment map (which may be referred to as an external environment map) acquired from the outside of the host vehicle via the communication unit 7 and an environment map (which may be referred to as an internal environment map) created by the map generation unit 114 by using recognition information of the external environment recognition unit 14 and detection values of the external sensor group 1 or detection values of the external sensor group 1 and the internal sensor group 2. The external environment map is an environment map acquired via, for example, a cloud server, and the internal environment map is an environment map created through mapping by using a technique such as the SLAM. The external environment map is shared by the host vehicle and other vehicles, whereas the internal environment map is a map independently included in the host vehicle.

The storage unit 12 may further store travel trajectory information indicating a travel trajectory.

The storage unit 12 may also store information regarding various control programs, thresholds used in the programs, or the like.

The external environment recognition unit 14 recognizes a curbstone, a wall, a groove, a guardrail, or a division line indicating a boundary of a road as a road boundary line on the basis of, for example, a camera image acquired by the camera 1a, and recognizes a road structure indicated by the road boundary line. As described above, the division line includes a white line (including lines of different colors), a curbstone line, a road stud, and the like, and a travel lane of the road is defined by markings based on these division lines and the like.

Note that an example in which the external environment recognition unit 14 recognizes a region sandwiched by road boundary lines as a region corresponding to a road has been disclosed, but a recognition method for a road is not limited thereto, and a road may be recognized according to other methods.

### <Travel Trajectory Acquisition Unit>

The travel trajectory acquisition unit 111 acquires a travel trajectory on which the host vehicle 101 has traveled. Position information (time-series position information) of the host vehicle 101 measured by the positioning unit 4 while the host vehicle 101 is traveling is temporarily recorded (which may be referred to as accumulated) in the storage unit 12. The travel trajectory acquisition unit 111 acquires the travel trajectory of the host vehicle 101 by reading and calculating the time-series position information accumulated in the storage unit 12.

Note that time-series sensor data measured by a wheel speed sensor and a steering angle sensor included in the internal sensor group 2 during traveling of the host vehicle 101 may be temporarily recorded in the storage unit 12. The travel trajectory acquisition unit 111 reads and calculates the time-series sensor data accumulated in the storage unit 12 to acquire the travel trajectory of the host vehicle 101.

The travel trajectory information indicating the travel trajectory acquired by the travel trajectory acquisition unit 111 may be stored in the storage unit 12 as described above.

When the time-series position information based on the travel trajectory information read from the storage unit 12 is arranged in time series on, for example, a two-dimensional map (in which a vertical axis represents an advancing direction (also referred to as a depth direction), and a horizontal axis represents a road width direction), the position information is discretely continued in the advancing direction. By calculating an approximate curve based on discrete points in the advancing direction for each traveling opportunity, an approximate curve corresponding to a traveling section is obtained for the number of times of traveling in the traveling section.

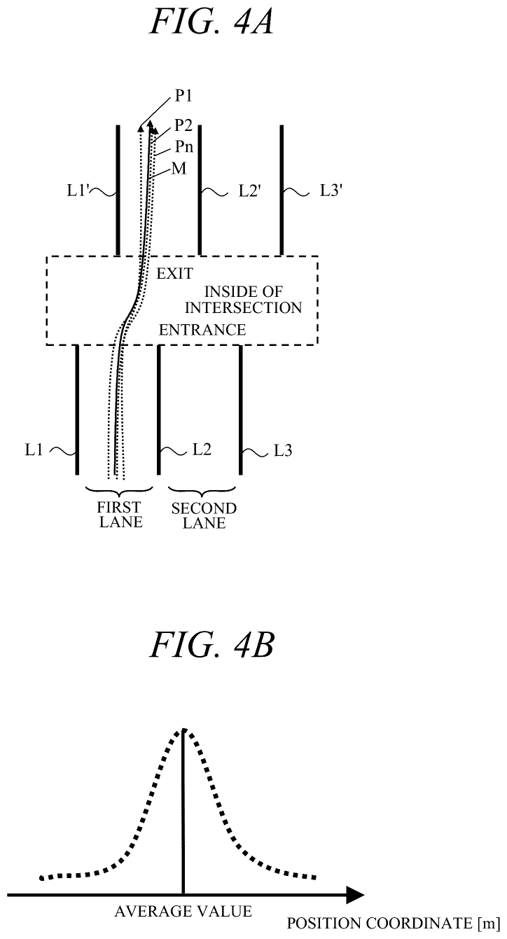

FIG. 4A is a schematic diagram illustrating a travel trajectory in a travel section including an intersection on the above two-dimensional map as viewed from above. The vertical direction in FIG. 4A corresponds to the advancing direction as viewed from the host vehicle 101, and the horizontal direction in FIG. 4A corresponds to the road width direction as viewed from the host vehicle 101. A region surrounded by a rectangular dashed line is the inside of an intersection. The division lines L1 to L3 are division lines that respectively define first and second lanes before a vehicle enters the intersection, and the division lines L1′ to L3′ are division lines that respectively define the first and second lanes after a vehicle leaves the intersection.

The n travel trajectories P1, P2, . . . , and Pn indicate n travel trajectories in a case where the vehicle travels in the first lane n times from the bottom to the top in FIG. 4A. The travel trajectory M corresponds to an average value of the travel trajectories P1, P2, . . . , and Pn.

The curvature calculation unit 112 that will be described later sets an average value of a plurality of approximate curves corresponding to the number of times of traveling as a travel trajectory M.

### <Curvature Calculation Unit>

On the basis of the travel trajectory information read from the storage unit 12, the curvature calculation unit 112 calculates a curvature (lane curvature) of the travel trajectory of the host vehicle 101 or the like in a specific scene such as an intersection where a travel lane marking is not provided and a merging region after a vehicle passes through a gate on an expressway. More specifically, after excluding a statistical outlier (singular data) from the travel trajectory information, the curvature calculation unit 112 calculates the travel trajectory M as an average value of the above-described travel trajectories P1, P2, . . . , and Pn, and calculates a curvature of the travel trajectory M.

The outlier may be excluded by using, for example, a random sample consensus (RANSAC) algorithm, and position information separated from other position information by a predetermined interval or more is excluded in a direction (road width direction) intersecting the advancing direction.

FIG. 4B is a schematic diagram illustrating a distribution of travel trajectories excluding an outlier. The vertical axis represents the number of occurrences, and the horizontal axis represents position coordinates in the road width direction. In the embodiment, a travel trajectory in the same section on the road acquired by the travel trajectory acquisition unit 111 corresponds to n samples, and an average value (sample average) u of the n samples corresponds to the travel trajectory M that is an average value of the travel trajectory in the section.

### <Lane Shape Estimation Unit>

The lane shape estimation unit 113 estimates a lane shape in the specific scene as follows on the basis of the curvature of the travel trajectory M of the host vehicle 101 or the like in the specific scene described above.

### First Estimation Example

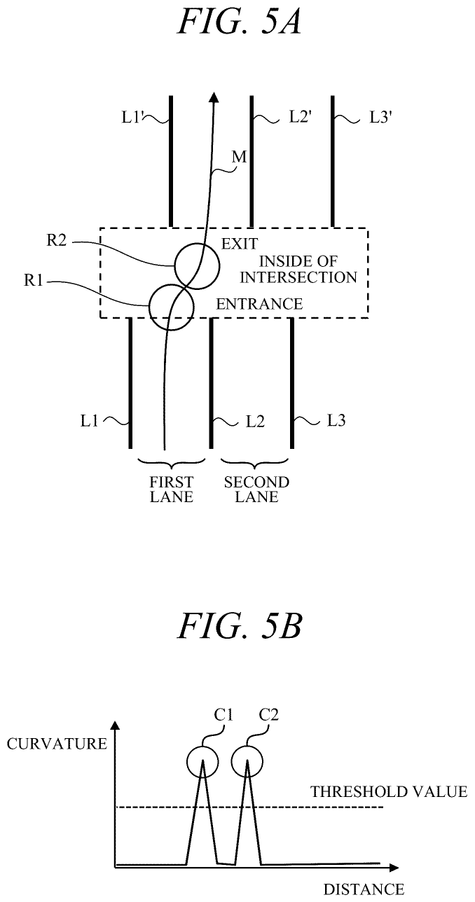

FIG. 5A is a schematic diagram illustrating a first estimation example for a lane shape. In a case where the specific scene is the inside of the intersection as illustrated in FIG. 5A where a travel lane marking is not provided and the curvature of the travel trajectory M calculated by the curvature calculation unit 112 is equal to or more than a predetermined value, the lane shape estimation unit 113 estimates a lane shape in the intersection from an approximate curve calculated on the basis of the travel trajectory M and lane shapes at the entrance and the exit of the intersection.

FIG. 5B is a diagram illustrating a curvature of the travel trajectory M in FIG. 5A, in which the vertical axis represents the magnitude of the curvature and the horizontal axis represents a distance in the advancing direction. In FIG. 5A, a curvature of a portion surrounded by a circle R1 corresponds to a portion surrounded by a circle C1 in FIG. 5B, and a curvature of a portion surrounded by a circle R2 in FIG. 5A corresponds to a portion surrounded by a circle C2 in FIG. 5B. Since the curvature exceeds a predetermined threshold value in FIG. 5B, the lane shape estimation unit 113 estimates a lane shape in the intersection from the approximate curve calculated on the basis of the travel trajectory M and the lane shapes at the entrance and the exit of the intersection.

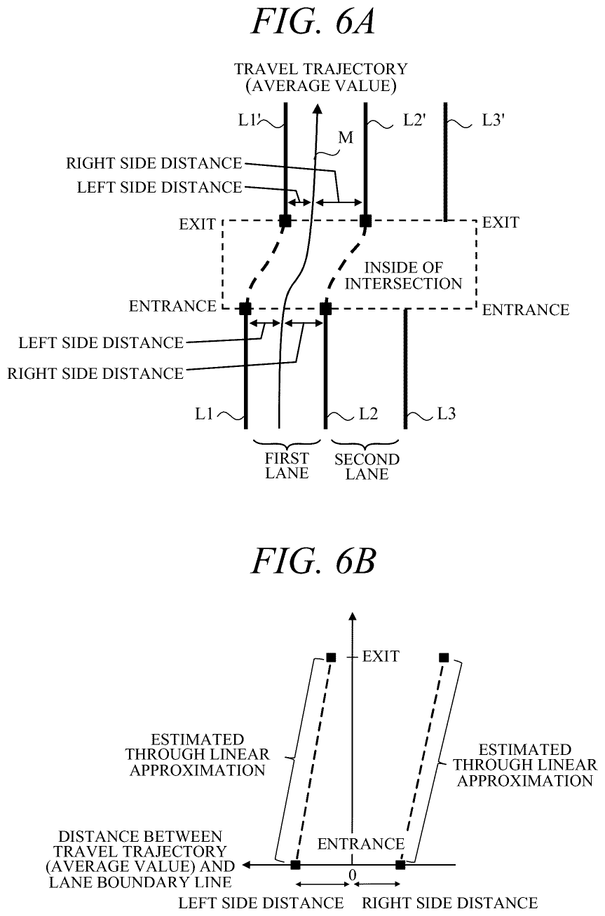

FIG. 6A is a schematic diagram describing the method according to the first estimation example in more detail. In FIG. 6A, an interval between a division line L1 defining a first lane at the entrance of the intersection and the travel trajectory M will be referred to as a left side distance. In addition, an interval between a division line L2 defining the first lane at the entrance of the intersection and the travel trajectory M will be referred to as a right side distance.

Similarly, an interval between a division line L1′ defining the first lane at the exit of the intersection and the travel trajectory M will be referred to as a left side distance. In addition, an interval between a division line L2′ defining the first lane at the exit of the intersection and the travel trajectory M will be referred to as a right side distance.

FIG. 6B is a diagram illustrating an example the travel trajectory M from the entrance to the exit of the intersection and a distance to a virtual lane boundary line. The lane shape estimation unit 113 estimates, through linear approximation, a change in the distance from the travel trajectory M in the intersection to the left and right virtual lane boundary lines from the entrance to the exit of the intersection on the basis of the distance between the travel trajectory M at the entrance and the exit of the intersection in FIG. 6A and the division lines L1, L2 and L1′, L2′ as the left and right lane boundary lines provided at the entrance and the exit. By using discrete points of the left and right virtual lane boundary lines calculated on the basis of the distance estimated through the linear approximation, a curved lane shape (in other words, left and right virtual lane boundary lines) in the intersection is estimated by using a non-linear approximation curve.

Note that FIGS. 5A and 5B illustrate an example in which the curvatures of two points in the intersection exceed the predetermined threshold value. However, when the curvature of at least one point in the intersection exceeds the predetermined threshold value, the lane shape estimation unit 113 estimates a lane shape in the intersection by using the method described in the first estimation example.

### Second Estimation Example

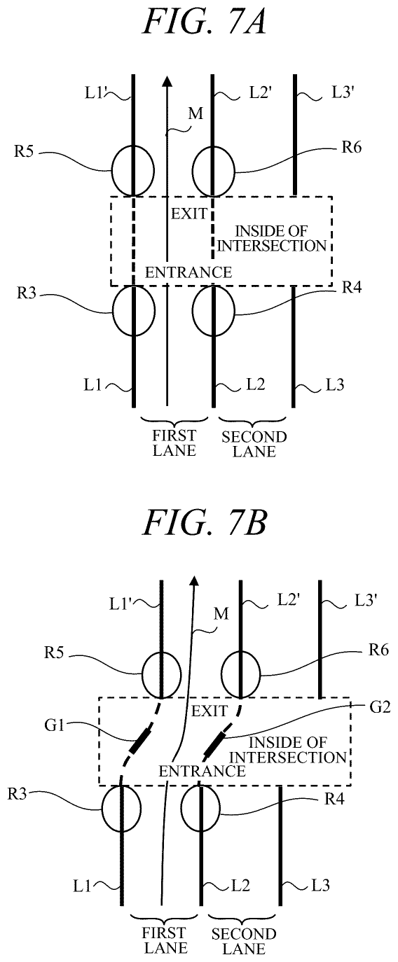

FIG. 7A is a schematic diagram illustrating a second estimation example for a lane shape. In a case where the specific scene is the inside of the intersection illustrated in FIG. 7A where a travel lane marking is not provided and the curvature of the travel trajectory M calculated by the curvature calculation unit 112 is less than the predetermined value, the lane shape estimation unit 113 estimates a lane shape in the intersection from an approximate curve calculated on the basis of lane shapes at the entrance and the exit of the intersection.

For example, left and right approximate curves (indicated by dashed lines in the intersection in FIG. 7A) as left and right virtual lane boundary lines connecting the lane shapes of the first lane defined by the division lines L1 and L2 as left and right lane boundary lines provided at the entrance and the lane shapes of the first lane defined by the division lines L1′ and L2′ as left and right lane boundary lines provided at the exit are calculated, and the lane shapes in the intersection are estimated from these left and right approximate curves.

### Third Estimation Example

FIG. 7B is a schematic diagram illustrating a third estimation example for a lane shape. In a case where the specific scene is the inside of the intersection illustrated in FIG. 7B where a travel lane marking is provided, the lane shape estimation unit 113 estimates a lane shape in the intersection from an approximate curve calculated on the basis of the lane shapes at the entrance and the exit of the intersection and a guidance marking.

For example, left and right approximate curves (indicated by dashed lines in the intersection in FIG. 7A) as left and right virtual lane boundary lines connecting the lane shapes of the first lane defined by the division lines L1 and L2 as left and right lane boundary lines provided at the entrance, left and right guide lines G1 and G2 as guidance markings provided in the intersection, and the lane shapes of the first lane defined by division lines L1′ and L2′ as left and right lane boundary lines provided at the exit are calculated, and a lane shape in the intersection is estimated from the left and right approximate curves.

### <Map Generation Unit>

The map generation unit 114 generates an environment map including position information indicating a position of a feature such as a division line on a road surface while traveling in the manual driving mode. Specifically, the map generation unit 114 generates an internal environment map including three-dimensional point group data. The map generation unit 114 extracts, for example, feature points of the feature recognized by the external environment recognition unit 14 from a camera image acquired by the camera 1a. The map generation unit 114 further obtains a distance from the host vehicle to the feature point by using distance measurement values based on the camera image or detection values from the LiDAR 1b, and sequentially plots the feature point at a position separated by the distance obtained above from the position of the host vehicle on the environment map estimated by the host vehicle position recognition unit 13 to generate an environment map of the surroundings of the road on which the host vehicle has traveled.

Note that, as described above, the map generation unit 114 may perform a map generation process not only in a case of traveling in the manual driving mode but also in a case of traveling in the automated driving mode in the same manner as in the manual driving mode.

In addition, for the specific scene described above, the map generation unit 114 causes information indicating the lane shape estimated by the lane shape estimation unit 113 to be included in (added to) the environment map.

### <Description of Flow Chart>

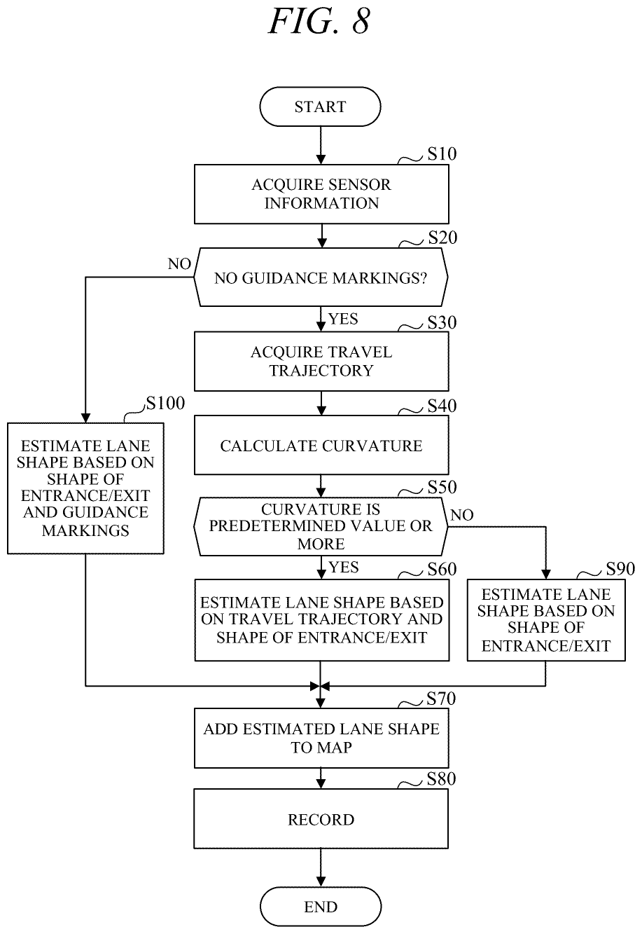

FIG. 8 is a flow chart showing an example of process executed by the controller 10 of FIG. 3 in accordance with a predetermined program. The processing shown in this flowchart is repeated at a predetermined cycle while driving in the manual driving mode, for example, to generate the environment map.

At step S10 (S: processing step) in FIG. 8, the controller 10 acquires sensor information from the camera 1a, the LiDAR 1b, and the sensor 2a and proceeds to S20.

At S20, the controller 10 determines whether there are no guidance markings within the intersection. If there are no guidance markings, the controller 10 makes an affirmative determination at S20 and proceeds to S30; if there are guidance markings, the controller 10 makes a negative determination at S20 and proceeds to S100.

At S30, the controller 10 acquires the travel trajectory and proceeds to S40. As described above, the travel trajectory information is stored in the storage unit 12. At S40, the controller 10 calculates the curvature of the travel trajectory M, which is the average value of the travel trajectories, by the curvature calculation unit 112 and proceeds to S50.

At S50, the controller 10 determines whether the curvature is equal to or more than the predetermined value. If the curvature the curvature is equal to or more than the predetermined value, the controller 10 makes an affirmative determination at S50 and proceeds to S60; if the curvature is less than the predetermined value, the controller 10 makes a negative determination at S50 and proceeds to S90.

At S60, the controller 10 estimates the lane shape of the intersection based on the travel trajectory M and the shape of the intersection's entrance and exit by the lane shape estimation unit 113 and proceeds to S70. The estimation at S60 corresponds to the first estimation example described above.

At S70, the controller 10 adds the information indicating the lane shape estimated at S60 to the environment map by the map generation unit 114 and proceeds to S80.

At S80, the controller 10 records the environment map, which includes the information indicating the lane shape, as the environment map information in the storage unit 12 and concludes the processing according to FIG. 8.

At S90, which is a step to which the controller 10 proceeds when a negative determination is made at S50, the controller 10 estimates the lane shape of the intersection based on the shape of the intersection's entrance and exit by the lane shape estimation unit 113 and proceeds to S70. The estimation at S90 corresponds to the second estimation example described above.

At S100, which is a step to which the controller 10 proceeds when a negative determination is made at S20, the controller 10 estimates the lane shape of the intersection based on the shape of the intersection's entrance and exit and the intersection's guidance markings by the lane shape estimation unit 113 and proceeds to S70. The estimation at S100 corresponds to the third estimation example described above.

According to the present embodiment, the following effects can be achieved.

(1) The map generation apparatus 50 includes the storage unit 12 that stores travel trajectory information indicating the travel trajectory M of the host vehicle 101, the external environment recognition unit 14 that recognizes a surrounding situation of the host vehicle 101, the curvature calculation unit 112 that calculates a curvature of the travel trajectory M in the intersection on the basis of the travel trajectory information read from the storage unit 12 in a case where an environment map as the traveling map information in the intersection as a specific scene is not acquired, a lane shape estimation unit 113 that estimates a lane shape in the intersection on the basis of the curvature calculated by the curvature calculation unit 112, and the map generation unit 114 that adds the lane shape estimated by the lane shape estimation unit 113 to the environment map.

With such a configuration, for example, in a case where an environment map as traveling map information in an intersection where a road marking for guidance along a travel route in the intersection or a guide line such as a cone is not provided is not acquired, it is possible to add an appropriate lane shape in the intersection estimated on the basis of the curvature of the travel trajectory M on which a vehicle has actually traveled through the intersection to the environment map.

(2) In the map generation apparatus 50 of the above (1), the specific scene is the inside of the intersection where the guide line or the like as a guidance marking for guidance along the travel route is not provided, the curvature calculation unit 112 calculates the curvature of the average value (travel trajectory M) of the travel trajectories in the intersection on the basis of the travel trajectory information, the lane shape estimation unit 113 estimates the lane shape in the intersection from the approximate curve calculated on the basis of the travel trajectory M and the lane shapes of the entrance and the exit of the intersection when the curvature calculated by the curvature calculation unit 112 is a predetermined value or more, and the map generation unit 114 adds the lane shape in the intersection estimated by the lane shape estimation unit 113 to the environment map.

With such a configuration, for example, since there is a deviation (which may be referred to as an offset) in the direction in which the entrance and the exit of the intersection intersect with the advancing direction, it is possible to appropriately estimate a lane shape in the intersection and add the lane shape to the environment map for the intersection where the curvature of the travel trajectory M that is an average value of the travel trajectories in the intersection is a predetermined value or more.

(3) In the map generation apparatus 50 of the above (2), the lane shape estimation unit 113 linearly approximates each change in a distance from the average value of the travel trajectories in the intersection from the entrance to the exit to the left and right virtual lane boundary lines on the basis of a distance between the average value of the travel trajectories at the entrance and the exit of the intersection based on the travel trajectory information and the left and right lane boundary lines provided at the entrance and the exit, and estimates the lane shape in the intersection with a nonlinear approximate curve by using discrete points of the left and right virtual lane boundary lines calculated on the basis of the distance estimated through the linear approximation, and the map generation unit 114 adds the lane shape in the intersection estimated by the lane shape estimation unit 113 to the environment map.

With such a configuration, it is possible to appropriately estimate the lane shape in the intersection where the deviation from the travel trajectory of the host vehicle 101 is small and close to an actual travel trajectory on the basis of the curvature of the travel trajectory M that is the average value of the travel trajectories and add the lane shape to the environment map.

(4) In the map generation apparatus 50 of the above (1), the specific scene is an intersection where a guidance marking for guidance along a travel route is not provided, the curvature calculation unit 112 calculates a curvature of an average value of travel trajectories in the intersection on the basis of the travel trajectory information, the lane shape estimation unit 113 estimates a lane shape in the intersection from an approximate curve calculated on the basis of lane shapes at the entrance and the exit of the intersection when the curvature calculated by the curvature calculation unit 112 is less than a predetermined value, and the map generation unit 114 adds the lane shape in the intersection estimated by the lane shape estimation unit 113 to the environment map.

With such a configuration, it is possible to appropriately estimate the lane shape in the intersection and add the lane shape to the environment map while reducing a calculation load as compared with the estimation calculation in the cases of the above (2) and (3) for the intersection where the curvature of the travel trajectory M that is an average value of the traveling trajectories in the intersection does not exceed a predetermined value.

(5) In the map generation apparatus 50 of the above (2) to (4), the specific scene is in an intersection where a guidance marking (for example, in addition to the road marking, an installation object such as a cone is included) for guidance along a travel route is installed, the lane shape estimation unit 113 estimates the lane shape in the intersection from the lane shapes of the entrance and the exit of the intersection and the approximate curve calculated on the basis of the guidance marking, and the map generation unit 114 adds the lane shape in the intersection estimated by the lane shape estimation unit 113 to the environment map.

With such a configuration, it is also possible to appropriately estimate the lane shape in the intersection and add the lane shape to the environment map for the intersection where a guide line such as a road marking or a cone for guidance along a travel route in the intersection is provided.

(6) In the map generation apparatus 50 of the above (1) to (4), the curvature calculation unit 112 detects a statistical outlier from a plurality of pieces of travel trajectory information, and calculates the curvature of the travel trajectory in a specific scene such as the intersection on the basis of the travel trajectory information excluding the outlier.

With such a configuration, by excluding irregular travel trajectory information (for example, an obstacle avoiding action in an intersection, or an action of giving way to an emergency vehicle or the like in the intersection) different from normal travel trajectory information existing in the travel trajectory information as an outlier, it is possible to more appropriately estimate the lane shape in the intersection.

The above embodiment can be modified in various forms. Hereinafter, modification examples will be described.

### First Modification Example

In the embodiment, an example in which the travel trajectory acquisition unit 111 independently acquires the travel trajectory information of the host vehicle 101 has been described. However, in a first modification example, an example in which travel trajectory information regarding a travel trajectory of another vehicle 102 or the like other than the host vehicle 101 is acquired via, for example, a cloud server will be described. That is, in the first modification example, the travel trajectory information is shared among a plurality of vehicles.

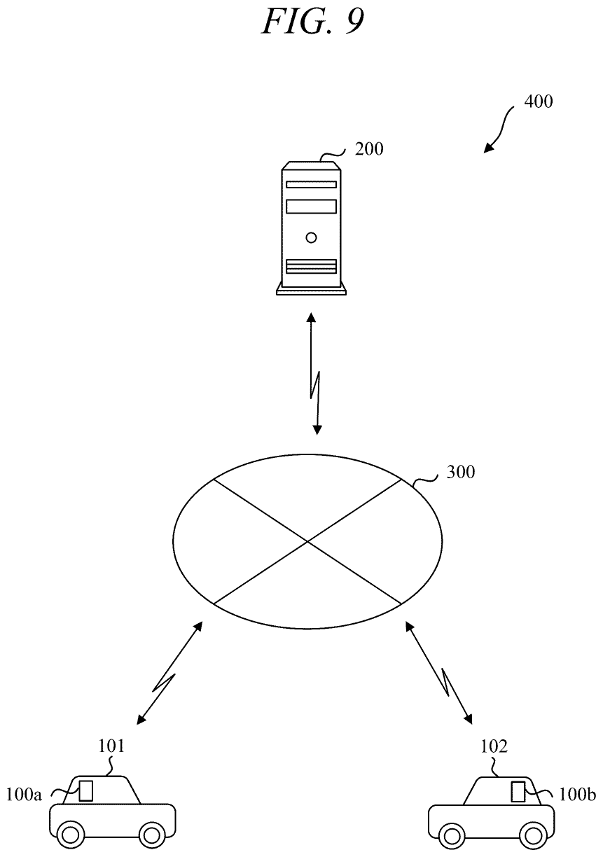

FIG. 9 is a diagram illustrating an example of a configuration of a road map generation system 400 according to the first modification example. In FIG. 9, the road map generation system 400 includes a server 200 connected to a communication network 300, and a vehicle control system 100a and a vehicle control system 100b configured to be communicatively connected to the communication network 300. The vehicle control system 100a is a vehicle control system 100 mounted on the host vehicle 101, and the vehicle control system 100b is a vehicle control system 100 mounted on another vehicle 102.

The server 200 is operated by, for example, a business entity or the like that provides a travel trajectory information sharing service. Configurations of the vehicle control systems 100a and 100b are similar to those of the vehicle control system 100 in the above-described embodiment.

The vehicle control systems 100a and 100b are connected to the communication network 300 such as a wireless communication network, the Internet, and a telephone network via the communication unit 7.

Although FIG. 9 illustrates two vehicles such as the host vehicle 101 and the other vehicle 102, the number of vehicles that can be connected to the communication network 300 is not limited to two, and there may be a large number of vehicles.

The vehicle control systems 100a and 100b of the host vehicle 101 and the other vehicle 102 respectively transmit the travel trajectory information of their vehicle stored in the storage unit 12 to the server 200 via the communication unit 7 at a predetermined transmission timing together with vehicle type information of their vehicle. The vehicle type information may be information for identifying at least a size or the like of a vehicle such as a passenger vehicle (which may also be referred to as a general vehicle), a bus, a truck, or a two-wheeled vehicle. In addition, the transmission timing may be appropriately set by a driver, for example, transmission once every week or transmission every predetermined travel distance.

When the travel trajectory information is transmitted from the vehicle control systems 100a and 100b mounted on the host vehicle 101 and the other vehicle 102, the server 200 stores the travel trajectory information in a database (not illustrated) for each size of the vehicle, for example.

In addition, upon receiving a request for travel trajectory information from the vehicle control systems 100a and 100b mounted on the host vehicle 101 and the other vehicle 102, the server 200 reads travel trajectory information of a vehicle corresponding to a size of a request source vehicle, the travel trajectory information being information in a specific scene of a region where the request source vehicle is traveling, from the database, and transmits the travel trajectory information to the request source vehicle.

When a travel trajectory is acquired in S30 in FIG. 8, the controller 10 of the host vehicle 101 or the like in the first modification example requests the server 200 for travel trajectory information in a region where the host vehicle 101 or the like is traveling. In this case, it is assumed that the server 200 is notified of position information of the host vehicle 101 or the like and vehicle type information of the host vehicle 101 or the like. As a result, the server 200 can transmit the travel trajectory information of the vehicle corresponding to the size of the request source vehicle to the request source vehicle.

The road map generation system 400 described in the first modification example described above includes the server 200 as a server device that acquires travel trajectory information from a plurality of vehicles such as the host vehicle 101 and stores the travel trajectory information in the database, and the curvature calculation unit 112 of the host vehicle 101 or the like calculates a curvature of the travel trajectory in a specific scene on the basis of the travel trajectory information from a plurality of vehicles stored in the database of the server 200.

With such a configuration, it is possible to estimate the lane shape in the intersection with higher reliability by incorporating the travel trajectory information of the other vehicle 102 and the like other than the host vehicle 101.

In addition, since a large number of pieces of travel trajectory information can be incorporated, statistical data close to true values can be obtained in a case where statistical values are used for calculation.

Furthermore, by incorporating the travel trajectory information of the vehicle corresponding to the size of the request source vehicle, for example, it is possible to exclude travel trajectory information of vehicles of other vehicle types having different vehicle widths, inner wheel differences, and the like, and to obtain travel trajectory information according to a traveling actual state of the vehicle corresponding to the size of the request source. As a result, it is possible to estimate a lane shape in the intersection with higher reliability.

### Second Modification Example

A curvature of a travel trajectory in a specific scene may be calculated on the basis of travel trajectory information of a vehicle other than a two-wheeled vehicle among pieces of travel trajectory information from a plurality of vehicles stored in the database of the server 200. That is, the curvature calculation unit 112 in the second modification example calculates a curvature of a travel trajectory in a specific scene on the basis of travel trajectory information of a vehicle other than a two-wheeled vehicle.

With such a configuration, it is possible to calculate a curvature by using only a travel trajectory away from a road end by excluding a travel trajectory of a two-wheeled vehicle which generally travels on the road end side in many cases, and thus, it is possible to calculate a curvature of a travel trajectory in accordance with a traveling actual state of a vehicle other than a two-wheeled vehicle. As a result, it is possible to estimate a lane shape in the intersection with higher reliability.

The above embodiment can be combined as desired with one or more of the aforesaid modifications. The modifications can also be combined with one another.

According to the present invention, it becomes possible to add an appropriate lane shape to a traveling map in a specific scene such as a deformed intersection.

Above, while the present invention has been described with reference to the preferred embodiments thereof, it will be understood, by those skilled in the art, that various changes and modifications may be made thereto without departing from the scope of the appended claims.

1. A map generation apparatus, comprising: a processor and a memory coupled to the processor, wherein
the memory is configured to store travel trajectory information indicating a travel trajectory of a vehicle, wherein
the processor is configured to perform:
recognizing surrounding situation of the vehicle;
calculating a curvature of the travel trajectory in a specific scene where traveling map information has not been acquired, based on the travel trajectory information stored in the memory;
estimating a lane shape in the specific scene based on the curvature; and
adding the lane shape to the traveling map information.

2. The map generation apparatus according to claim 1, wherein
the specific scene includes an intersection without a guidance marking for guiding a travel route, wherein
the processor
calculates the curvature of an average value of the travel trajectory in the intersection based on the travel trajectory information;
estimates the lane shape in the intersection from an approximate curve calculated based on the average value of the travel trajectory and the lane shape at an entrance and an exit of the intersection when the curvature is equal to or more than a predetermined value; and
adds the lane shape in the intersection to the traveling map information.

3. The map generation apparatus according to claim 2, wherein
the processor
linearly approximates each change in a distance from the average value of the travel trajectory in the intersection from the entrance to the exit to left and right virtual lane boundary lines based on a distance between the average value of the travel trajectory at the entrance and the exit of the intersection and the left and right lane boundary lines at the entrance and the exit;
estimates the lane shape in the intersection with a nonlinear approximate curve by using discrete points of the left and right virtual lane boundary lines calculated based on the change; and
adds the lane shape in the intersection to the traveling map information.

4. The map generation apparatus according to claim 1, wherein
the specific scene includes an intersection without a guidance marking for guiding a travel route, wherein
the processor
calculates the curvature of an average value of the travel trajectory in the intersection based on the travel trajectory information;
estimates the lane shape in the intersection from an approximate curve calculated based on the lane shape at an entrance and an exit of the intersection when the curvature is less than a predetermined value; and
adds the lane shape in the intersection to the traveling map information.

5. The map generation apparatus according to claim 2, wherein
the specific scene further includes an intersection with the guidance marking, wherein
the processor
estimates the lane shape in the intersection with the guidance marking from an approximate curve calculated based on the lane shape at an entrance and an exit of the intersection with the guidance marking and the guidance marking; and
adds the lane shape in the intersection with the guidance marking to the traveling map information.

6. The map generation apparatus according to claim 1, wherein
the processor
detects a statistical outlier from a plurality of pieces of the travel trajectory information; and
calculates the curvature based on the travel trajectory information excluding the outlier.

7. The map generation apparatus according to claim 1, wherein
the travel trajectory information indicates the travel trajectory of the vehicle in a manual driving mode that requires driving operation of a driver.

8. The map generation apparatus according to claim 1, wherein
the traveling map information is used in an automated driving mode that does not require driving operation of a driver.

9. A map generation system, comprising:
the map generation apparatus according to claim 1; and
a server device configured to acquire and store the travel trajectory information from a plurality of the vehicle, wherein
the processor calculates the curvature of the travel trajectory in the specific scene based on the travel trajectory information of the vehicle other than a two-wheeled vehicle from among the travel trajectory information stored in the server device.
